(19) United States
(12) Patent Application Publication
(10) Pub. No.: US 2014/0096367 A1
(43) Pub. Date: Apr. 10, 2014

(54) MAGNETIC CLAMP ATTACHMENT ASSEMBLY

(71) Applicant: SERPENT AND DOVE - APPLIED MAGNETICS PTY LTD, New South Wales (AU)

(72) Inventors: Ian Godfrey HEARD, New South Wales (AU); Adrian Edward HEARD, New South Wales (AU)

(73) Assignee: SERPENT AND DOVE - APPLIED MAGNETICS PTY LTD, New South Wales (AU)

(21) Appl. No.: 14/050,061

(22) Filed: Oct. 9, 2013

(30) Foreign Application Priority Data
Oct. 10, 2012 (AU) 2012904425
Apr. 11, 2013 (AU) 2013204035

(51) Int. Cl. E06C 7/18

(52) U.S. Cl. CPC E06C 7/188
USPC 29/525.08; 182/107

(57) ABSTRACT

A magnetic clamp attachment assembly for securing a ladder arrangement to a ferromagnetic surface is disclosed where the ladder arrangement comprises two spaced apart side members and at least one rung extending between the side members. The magnetic clamp attachment assembly includes a spacer member sized and configured to extend over the spaced apart side members of the ladder arrangement and magnetic attachment means for attaching the spacer member and securing the ladder arrangement to the ferromagnetic surface.

### PRIORITY DOCUMENTS

The present application claims the benefit of:

Australian Provisional Patent Application No. 2012904425 titled “MAGNETIC CLAMP ATTACHMENT ASSEMBLY” and filed on 10 Oct. 2012; and

Australian Complete Patent Application No. 2013204035 titled “MAGNETIC CLAMP ATTACHMENT ASSEMBLY” and filed on 11 Apr. 2013. The content of each of these applications is hereby incorporated by reference in its entirety.

### TECHNICAL FIELD

The present invention relates to a magnetic clamp attachment assembly for attachment to a ferromagnetic material. In a particular form, the present invention relates to a magnetic clamp attachment assembly for securing a ladder arrangement to a ferromagnetic surface.

### BACKGROUND

Ladders are a convenient means to provide access to regions at different heights. In some instances, ladder arrangements are attached to a surface such as a wall but more typically a ladder is temporarily deployed in order to provide access. In these circumstances, it is desirable to have some means to temporarily fix the ladder to the surface to address safety concerns. In one non-limiting example of this type of arrangement, a rope ladder consisting of two substantially parallel spaced apart flexible cords, or pairs of cords, with a number of rungs extending between the flexible cords is deployed over the side of a ship to provide access for marine pilots who will board a ship on entry into a harbour to pilot the ship for docking.

The pilot will typically be conveyed to the ship by a smaller vessel that comes alongside the ship and then steps onto and climbs the rope ladder to gain access to the deck. As would be appreciated, safety is of utmost importance and means to secure the ladder to the ship hull to prevent sway are required. These have involved the use of individual suction and permanent magnetic type attachment devices that attach to the hull of the ship and to which is attached the rope ladder. Typically, a ladder will be lowered down the side of the ship and then an operator wearing a suitable safety harness descends the ladder and deploys the magnets individually onto the hull of the ship and then lashes the ladder to the tie-off points provided by the magnets.

This operation requires considerable skill and experience as the magnets must be placed precisely to ensure that the ladder is properly located and aligned when it is secured to the magnets. Depending on the circumstances, this operation may need to be carried out under unsuitable lighting or inclement weather conditions further contributing to the difficulty of positioning the magnets and further attaching the rope ladder. In addition, where individual permanent magnets are used as the attachment device, these can be difficult to handle and manipulate and can potentially cause pinch injuries to fingers or hands if not used correctly.

There is therefore a need for attachment device that is capable of alleviating one or more of the disadvantages of current attachment devices or to provide consumers with an alternative choice.

### SUMMARY

In a first aspect the present invention accordingly provides a magnetic clamp attachment assembly for securing a ladder arrangement to a ferromagnetic surface, the ladder arrangement comprising two spaced apart side members and at least one rung extending between the side members, the magnetic clamp attachment assembly comprising:

a spacer member sized and configured to extend over the spaced apart side members of the ladder arrangement; and

magnetic attachment means for attaching the spacer member and securing the ladder arrangement to the ferromagnetic surface.

In another form, the magnetic attachment means are located substantially at the ends of the spacer member.

In another form, the magnetic attachment means include permanent magnets.

In another form, the permanent magnets are manually switchable from an off state to an on state to attach the spacer member and the ladder arrangement to the ferromagnetic surface.

In another form, the spacer member includes adjustable spacer length means to adjust the length of the spacer member.

In another form, the adjustable spacer length means includes two members slidably mounted with respect to each other so that their combined length may be varied.

In another form, the two members are slidably mounted with respect to each other by a telescoping arrangement.

In another form, the spacer member is adapted to extend over a rung or stabiliser bar of the ladder arrangement.

In another form, the attachment assembly includes flexible mounting means to allow the orientation of the magnetic attachment means to vary with respect to the spacer member to accommodate for any curvature of the ferromagnetic surface.

In another form, the flexible mounting means includes a pad or washer of compressible material located between the magnetic attachment means and the ends of the spacer member.

In another form, the attachment assembly includes adjustment means to adjust the distance between the spacer member and the ferromagnetic surface.

In another form, the spacer member is operable to flex to accommodate for any curvature of the ferromagnetic surface.

In another form, the spacer member includes contact means arranged to contact the ladder arrangement on attachment of the attachment assembly to the ferromagnetic surface.

In another form, the contact means is an elongate compressible strip extending along the spacer member.

In another form, the ladder arrangement is a pilot ladder and the ferromagnetic surface is a hull of a ship.

In a second aspect the present invention accordingly provides a method for securing a ladder arrangement to a ferromagnetic surface, the method including:

deploying the ladder arrangement; and attaching a magnetic clamp attachment assembly to the ferromagnetic surface, the magnetic clamp attachment assembly sized and configured to extend over the ladder arrangement.

In another form, deploying the ladder arrangement includes lowering the ladder arrangement from an upper region of the ferromagnetic surface to a lower region to allow access to the upper region.

In another form, attaching the magnetic clamp attachment assembly includes lowering the attachment assembly to the lower region and attaching the attachment assembly at or near the lower region to secure the ladder arrangement.

In another form, the step of attaching the magnetic clamp attachment assembly includes activating one or more permanent magnets from an off state to an on state to attach to the ferromagnetic surface.

### BRIEF DESCRIPTION OF DRAWINGS

Embodiments of the present invention will be discussed with reference to the accompanying drawings wherein:

FIG. 1 is a front view of a magnetic clamp attachment assembly for securing a ladder arrangement to a ferromagnetic surface in accordance with an illustrative embodiment of the present invention;

FIG. 2 is a top view of the magnetic clamp attachment assembly illustrated in FIG. 1;

FIG. 3 is a front view of the magnetic clamp attachment assembly illustrated in FIG. 1 as deployed to secure a ladder arrangement to a ferromagnetic surface;

FIG. 4 is a top view of the deployed magnetic clamp attachment assembly illustrated in FIG. 3;

FIG. 5 is a rear perspective view of a magnetic clamp attachment assembly for securing a ladder arrangement to a ferromagnetic surface in accordance with a further illustrative embodiment of the present invention;

FIG. 6 is a detailed view of the switchable permanent magnets of the magnetic clamp attachment assembly illustrated in FIG. 5; and

FIG. 7 is an end on perspective view of a magnetic clamp attachment assembly in accordance with yet another illustrative embodiment of the present invention.

In the following description, like reference characters designate like or corresponding parts throughout the figures.

### DESCRIPTION OF EMBODIMENTS

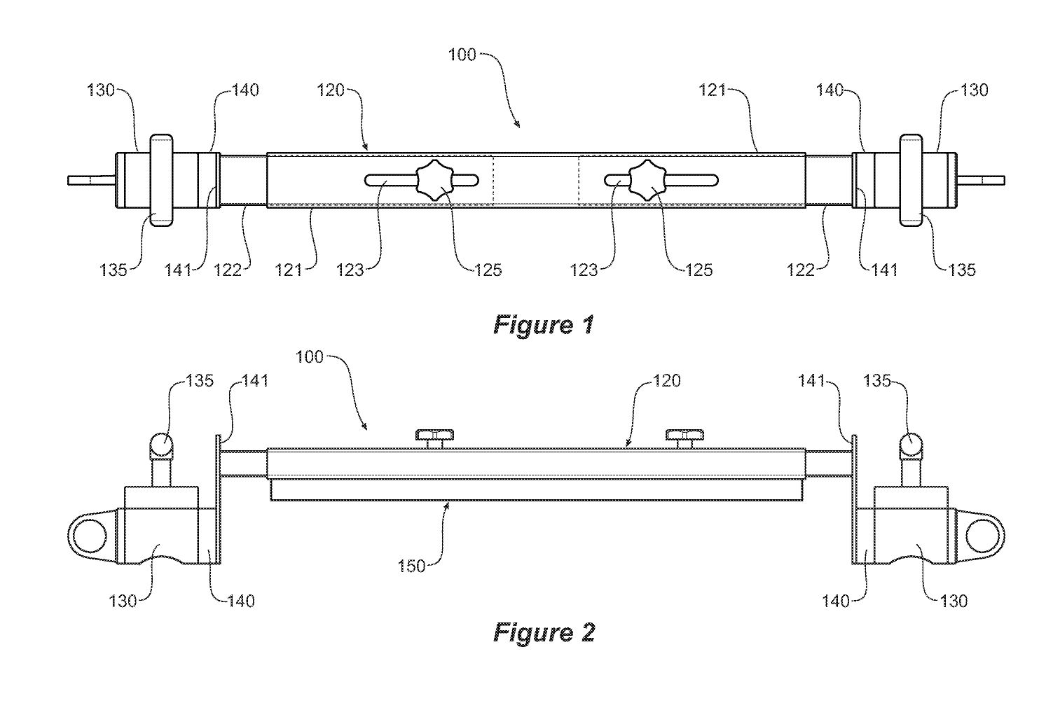

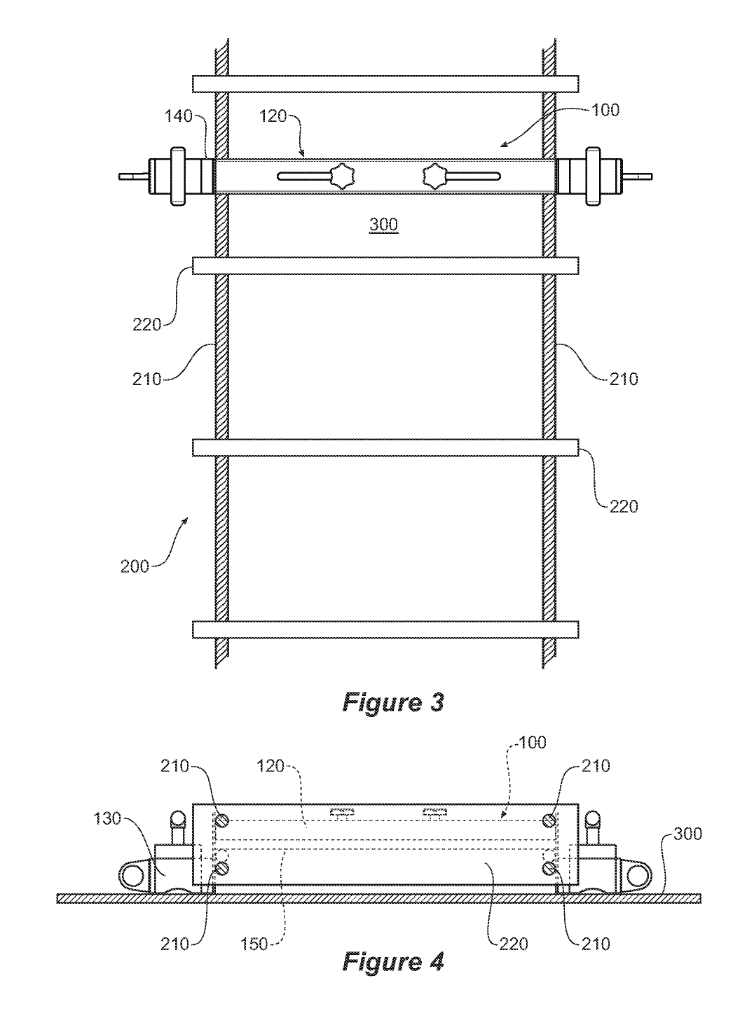

Referring now to FIGS. 1 to 4, there are shown various views of a magnetic clamp attachment assembly 100 for securing a ladder arrangement 200 to a ferromagnetic surface 300 according to an illustrative embodiment of the present invention. In this illustrative embodiment, clamp attachment assembly 100 is for attaching a rope ladder to the steel hull of a ship but as would be apparent to those of ordinary skill in the art the attachment assembly 100 will have other applications where it is necessary to secure a ladder to a ferromagnetic surface including, but not limited to, securing a ladder to a tank, wall, tower, structure or frame formed of a suitable ferromagnetic material.

Magnetic clamp attachment assembly 100 includes a spacer member 120 that is sized and configured to extend over the side members 210 of the ladder arrangement 200 that are to be secured to the ferromagnetic surface 300. In the case of a rope ladder, the side members will be flexible cords, and in this case the side members comprise multiple cords on each side of ladder arrangement 200. In other arrangements, the side members may comprise individual cords. Equally the side members may be rigid or semi-rigid as the case may be depending on requirements. Located in this embodiment at the ends of spacer member 120 are magnetic attachment means consisting of two permanent magnets 130 that function to attach spacer member 120 and hence secure the ladder arrangement 200 to the ferromagnetic surface. In other embodiments, the magnetic attachment means may consist of one or more magnets positioned on or along spacer member 120 as appropriate.

In this illustrative embodiment, magnets 130 are switchable permanent magnet clamps that are switched on by a handle 135 that is depressed and rotated to turn internal magnet elements into position to concentrate magnetic flux at the magnetising surface. One illustrative example of a switchable permanent magnet suitable for magnetic clamp attachment assembly 100 is the MagSquare 400™ which is available from Magswitch Technology (Worldwide) Pty Ltd. This device provides a powerful magnetic field on a 180° turn of handle 135. Magnetic clamp attachment assembly 100 further includes flexible mounting means 140 in form of a compressible washer of suitable resilient material such as neoprene or the like that allows the orientation of the permanent magnet clamps 130 to vary with respect to spacer member 120 to accommodate any curvature in the ferromagnetic surface such as would be present in relation to the hull of a ship.

Magnetic clamp attachment assembly 100 in this illustrative embodiment further includes adjustable spacer length means that functions to allow the length of the spacer member 120 to be adjusted. This allows attachment assembly 100 to be modified in accordance with the configuration of the ladder arrangement 200 and, in particular, the width between the side members 210. In this exemplary embodiment, adjustable spacer length means consists of a slideable arrangement wherein spacer member 120 includes a first member 121 that is slidably mounted to a second member 122 so that the length of the combined first and second members 121, 122 may be varied. In this example, first member 121 is adapted to slidably receive second member 122 by forming a telescoping sleeve. Adjustable spacer length means in this illustrative embodiment further includes a locking means 125 such as a bolt or screw or lever that extends through slot 123 to apply frictional resistance to the movement of second member 122 with respect to first member 121.

Spacer member 120 may be formed of any suitable material that provides the spacing functionality. In the embodiment depicted in FIGS. 1 to 4, spaced member is formed of tubular aluminium channel sections which may be of circular or rectangular cross section and which are able to telescope with respect to each other. In another illustrative embodiment, spacer member may be formed of a suitable flexible plastic or synthetic material including, but not limited to, nylon, delrin or high density polyethylene (HDPE). As depicted in FIG. 1, magnetic clamp attachment assembly 100 includes two opposed slidable arrangements as described above in order to provide additional flexibility in modifying the length of spacer member 120.

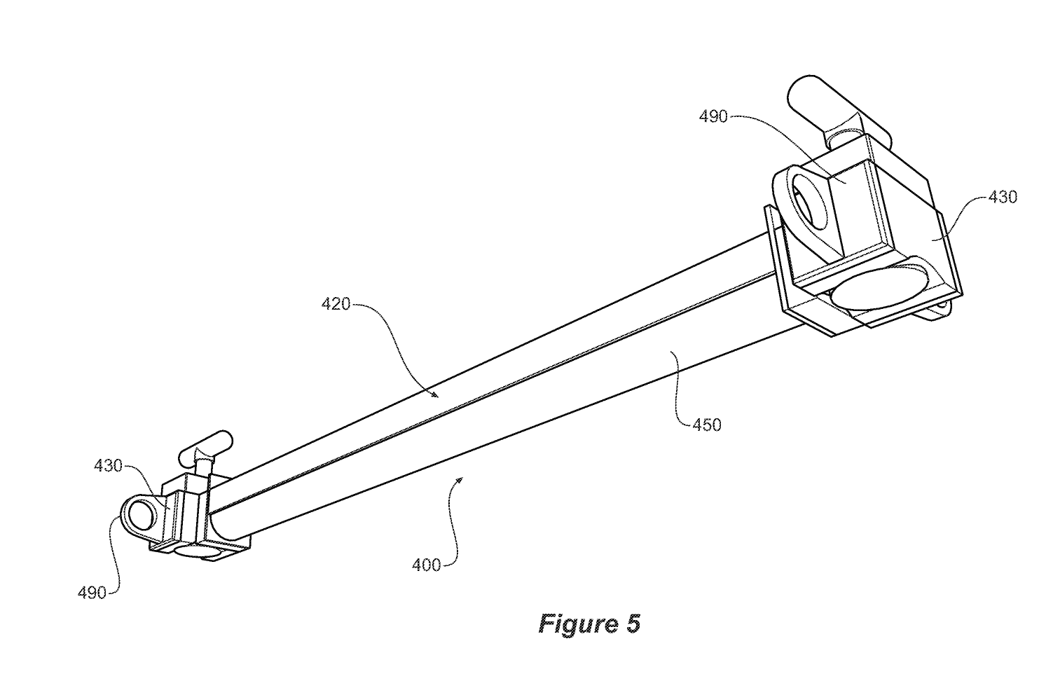

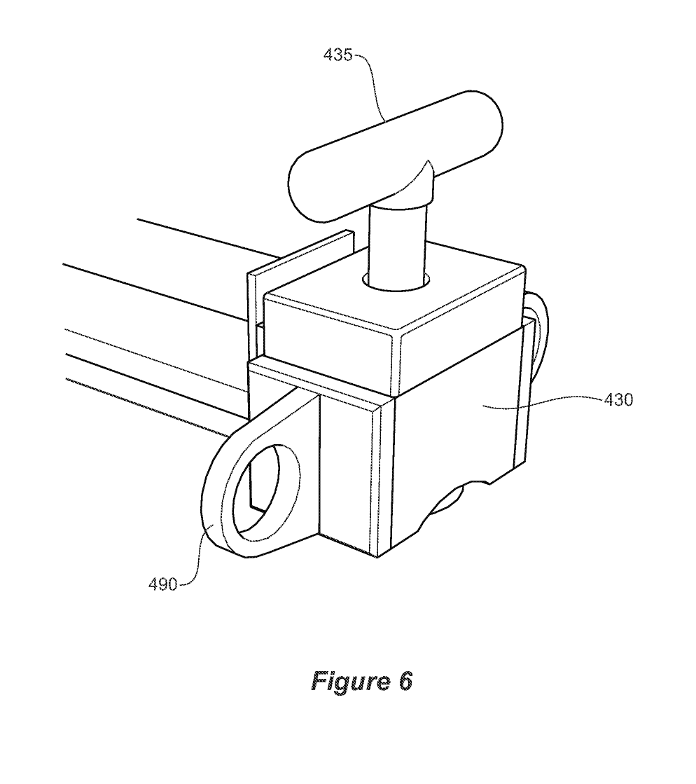

Referring now to FIGS. 5 and 6, there is shown perspective and close up views of a magnetic clamp attachment assembly 400 in accordance with a further embodiment where the spacer member 420 is formed of a solid section of aluminium and which includes switchable magnets 430 having handles 435 analagous to those of attachment assembly 100. In this illustrative embodiment, magnetic clamp attachment assembly 400 further includes additional top and bottom rings or attachment locations 490 for further tethering if required. In this example, the attachment locations 490 are located on the switchable magnets 430 but equally they may be located on spacer member 420 if required.

Magnetic clamp attachment assembly 100 further includes an elongate compressible strip 150 that extends along spacer member 120 which provides a compressible surface that is applied against the ladder when attachment assembly 100 is clamped to the ferromagnetic surface (see also item 450 in FIG. 4). This compressible surface 150 further functions to locate and restrain movement of the ladder arrangement 200 by bearing against side members 210. In another embodiment, spacer member 120 includes spaced apart channels that receive the side ropes or members 210 of ladder arrangement 200. In yet another embodiment, spacer member 120 is adapted to extend over a rung 210 or bar of the ladder arrangement 200. In yet a further embodiment, the distance between the spacer member 120 and the surface to which the magnetic clamp attachment assembly 100 is attached to may be adjusted. In one exemplary embodiment, the flexible mounting means 140 includes the ability to adjust this distance.

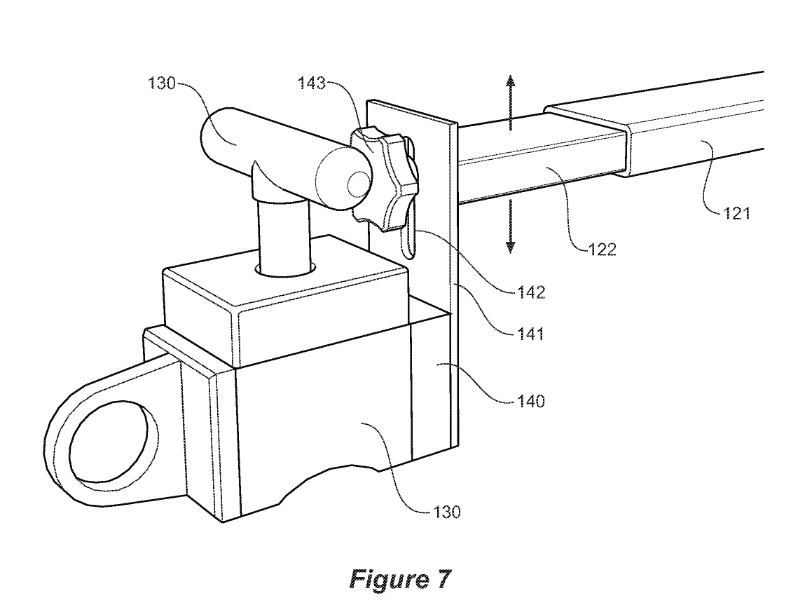

Referring now to FIG. 7, there is shown an end on perspective view of a magnetic clamp attachment assembly in accordance with another illustrative embodiment which allows the distance between spacer member 120 and the surface to be varied as described above. In this illustrative embodiment, the side support or plate member 141 attached to compressible washer 140 includes a vertical slot 142 and bolt arrangement 143 that allows spacer member 120 to be moved vertically 142.

In use, a magnetic clamp attachment assembly 100, 400 in accordance with the present invention may be deployed in a number of ways. Typically, as previously described, the ladder arrangement 200 will be deployed down the side of the ship. An operator may then descend with one or more attachment assemblies and simply position these over the ladder arrangement 200 to secure the ladder arrangement 200 to the hull. Depending on requirements, the spacer member will be positioned in line with and just below a rung 220 of the ladder arrangement 200 or alternatively just below a stabiliser bar (not shown) in the case of a pilot ladder. Where the attachment assembly includes switchable magnets, the operator will first align and position the attachment assembly and then activate the magnets by turning the handle. In another embodiment, the spacer member 120 may be adapted to extend over the rung or stabiliser bar itself.

In another mode of operation, the magnetic clamp attachment assembly may be lowered to the pilot vessel where personnel of the pilot vessel can then place it up against the hull over the ladder arrangement 200 and then turn the magnets to secure the ladder arrangement 200. In yet another mode of use, an operator from the ship may descend via an accommodation ladder and attach one or more magnetic clamp attachment assemblies to the hull of the vessel to secure the ladder arrangement 200.

A magnetic clamp attachment assembly in accordance with the previously described embodiments provides a number of important advantages over prior art arrangements. The primary advantage is that the assembly allows for a spacer member to be attached conveniently in a manner that functions to secure the ladder arrangement by extending over it. In this manner, it is not necessary to separately attach and align individual magnets and then further secure the ladder arrangement to the respective individual magnets.

In those embodiments where the magnetic clamp attachment assembly includes switchable magnets, the device is not only more convenient to be deployed by an experienced operator but it may be provided to, in this case, the pilot vessel where relatively untrained personnel may deploy that attachment assembly at the lower end of the ladder arrangement. In the case where more than one attachment assembly is required, the initial securing of the lower end of the ladder arrangement will facilitate the positioning and attachment of further attachment assemblies to secure the ladder arrangement 200.

While magnetic clamp attachment assembly has been described with reference to a rope ladder, it would be apparent that it could be equally applied to other types of standard ladder arrangements formed of rigid side members and rungs.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A magnetic clamp attachment assembly for securing a ladder arrangement to a ferromagnetic surface, the ladder arrangement comprising two spaced apart side members and at least one rung extending between the side members, the magnetic clamp attachment assembly comprising:
a spacer member sized and configured to extend over the spaced apart side members of the ladder arrangement; and
magnetic attachment means for attaching the spacer member and securing the ladder arrangement to the ferromagnetic surface.

2. The magnetic clamp attachment assembly of claim 1, wherein the magnetic attachment means are located substantially at the ends of the spacer member.

3. The magnetic clamp attachment assembly of claim 1, wherein the magnetic attachment means include permanent magnets.

4. The magnetic clamp attachment assembly of claim 3, wherein the permanent magnets are manually switchable from an off state to an on state to attach the spacer member and the ladder arrangement to the ferromagnetic surface.

5. The magnetic clamp attachment assembly of claim 1, wherein the spacer member includes adjustable spacer length means to adjust the length of the spacer member.

6. The magnetic clamp assembly of claim 5, wherein the adjustable spacer length means includes two members slidably mounted with respect to each other so that their combined length may be varied.

7. The magnetic clamp attachment assembly of claim 6, wherein the two members are slidably mounted with respect to each other by a telescoping arrangement.

8. The magnetic clamp attachment assembly of claim 1, wherein the spacer member is adapted to extend over a rung or stabiliser bar of the ladder arrangement.

9. The magnetic clamp attachment assembly of claim 1, wherein the attachment assembly includes flexible mounting means to allow the orientation of the magnetic attachment means to vary with respect to the spacer member to accommodate for any curvature of the ferromagnetic surface.

10. The magnetic clamp attachment assembly of claim 9, wherein the flexible mounting means includes a pad or washer of compressible material located between the magnetic attachment means and the ends of the spacer member.

11. The magnetic clamp attachment assembly of claim 1, wherein the attachment assembly includes adjustment means to adjust the distance between the spacer member and the ferromagnetic surface.

12. The magnetic clamp attachment assembly of claim 1, wherein the spacer member is operable to flex to accommodate for any curvature of the ferromagnetic surface.

13. The magnetic clamp attachment assembly of claim 1, wherein the spacer member includes contact means arranged to contact the ladder arrangement on attachment of the attachment assembly to the ferromagnetic surface.

14. The magnetic clamp attachment assembly of claim 13, wherein the contact means is an elongate compressible strip extending along the spacer member.

15. The magnetic clamp attachment assembly of claim 1, wherein the ladder arrangement is a pilot ladder and the ferromagnetic surface is a hull of a ship.

16. A method for securing a ladder arrangement to a ferromagnetic surface, the method including:
deploying the ladder arrangement; and
attaching a magnetic clamp attachment assembly to the ferromagnetic surface, the magnetic clamp attachment assembly sized and configured to extend over the ladder arrangement.

17. The method of claim 16, wherein deploying the ladder arrangement includes lowering the ladder arrangement from an upper region of the ferromagnetic surface to a lower region to allow access to the upper region.

18. The method of claim 17, wherein attaching the magnetic clamp attachment assembly includes lowering the attachment assembly to the lower region and attaching the attachment assembly at or near the lower region to secure the ladder arrangement.

19. The method of claim 16, wherein the step of attaching the magnetic clamp attachment assembly includes activating one or more permanent magnets from an off state to an on state to attach to the ferromagnetic surface.
